(19) United States
(12) Patent Application Publication
(10) Pub. No.: US 2013/0026219 A1
(43) Pub. Date: Jan. 31, 2013

(54) ARTICLE AND METHOD FOR AN ELECTRONICALLY READABLE STICKER

(71) Applicants: John Wayne Applegate, Bordentown, NJ (US); Frederick George Tingley, Haddon Township, NJ (US)

(72) Inventors: John Wayne Applegate, Bordentown, NJ (US); Frederick George Tingley, Haddon Township, NJ (US)

(73) Assignee: FRANKLIN ELECTRONIC PUBLISHERS, INCORPORATED, Burlington, NJ (US)

(21) Appl. No.: 13/189,868

(22) Filed: Jul. 25, 2011

(51) Int. Cl. G06K 19/02; G06F 17/00; G06K 19/06

(52) U.S. Cl. 235/375; 235/494; 235/487

(57) ABSTRACT

A substantially transparent label that uses substantially transparent attachments to attach the label to an object where the label carries at least one identifier capable of being read by an electronic aid. The label with the identifiers is an example of a data carrier. A data carrier can be used by associating an audio recording with an identifier on a data carrier with the use of an electronic aid. The data carrier can be divided into a series of segments, each having at least one identifier. Each segment can be attached to a plurality of identical tangible objects. Each segment can be read with an electronic aid to recite the stored audio information.

### FIELD OF THE INVENTION

The present invention relates in general to data carriers and in particular a data carrier for use with an electronic aid adapted for reading an identifier printed on the data carrier. The invention further relates to a method of information recitation utilizing at least one data carrier and at least one electronic aid.

### BACKGROUND OF THE INVENTION

There are many uses of data carriers that are adapted to be read by an electronic aid capable of reading an identifier printed on the data carrier. Data carriers can typically take the form of labels or sheets of paper. Identifiers can take the form of one or more patterns of dots on the data carrier that may be too small to be visually perceived by a human reader, but can be read by an electronic aid adapted for that purpose. In other circumstances, the identifiers can be printed with various inks in the visual spectrum or the ultra violet spectrum. Identifiers can also be encoded with magnetism. Identifiers can be printed in a grid pattern with an x and y axis. Alternatively, identifiers can be printed in a radial pattern. Identifiers can also be printed in various other patterns and techniques commonly used in the art. Often, a plurality of identifiers is found on a single data carrier, thereby permitting the electronic aid to read the identifier at any number of places on the surface of a data carrier. In many instances, the electronic aid uses reference points on the identifier to read the identifier in any rotational orientation through the use of a software algorithm.

Data carriers capable of being read by the use of an electronic aid can be used for various purposes. One common application generally involves the use of a data carrier that is affixed to an item, such as a container of medicine. Next, an electronic aid typically scans the identifier on the data carrier. Next, the electronic aid enters into a recording mode capable of storing sound information supplied by a user. This may be an audio clip corresponding to a the name of a medication, the dosage of medication to be taken, or instructions for taking such medication, for example. The sound information is associated with the particular identifier and stored in the electronic aid, along with a reference to identifier. This linkage permits the data reader to subsequently read the same identifier and automatically play back the sound recording with an audio output mechanism on the data reader.

For example, U.S. patent application Ser. No. 12/989,426 discloses the use of labels with identifiers that can be affixed, for example, to food items in order to assist visually impaired individuals with article identification. The '426 application discloses that the “label 11 is preferably blank and of a material such that the label 11 can be written or drawn on with ink. In other arrangements, however, the label 11 may not be blank, but may instead be coloured or be provided with pre-printed text and/or drawings on the side of the label 11 carrying the coded dots 12.”

Data carriers can also be printed directly on a page as not to interfere with a reader's ability to perceive information on the page, as generally disclosed in U.S. Pat. No. 7,328,845.

A need exists in the art to have labels that can be placed on objects without obscuring the underlying information on the object. For example, if a blank or colored label was placed over the page of a book, it would obscure the underlying text or pictures that may be present on a page.

A need also exists to place data carriers on a page in a manner that will not interfere with a reader's ability to perceive information on the page without having to produce the page with the data carrier printed with the underlying image. Printing the data carriers and the text or graphics of a page at the same time prevents a user from adding a data carrier after the production of the underlying text or graphic content.

Furthermore, a need exists to efficiently label objects in a collection with data carriers. Circumstances arise when it is useful to use an electronic aid to record an audio message that would be played back in association with related tangible objects. For example, it is useful to label identical items in a collection of tangible objects with the same data carrier identifier in order to permit the same audio message to be recited while at the same time not obscuring the tangible object or damaging it with any permanent markings.

It is also useful to label different plaques around an animal enclosure at a zoo with the same data carrier identifier to communicate the same audio information pertaining to a given zoo animal in a manner that does not obscure any underlying textual or graphical information contained on plaques around the animal's enclosure.

It is also useful to label identical pages in identical books, identical places on identical worksheets, or identical places on identical academic test papers with the same data carrier identifier to communicate the same audio information pertaining to the content of the book, worksheet or test paper in a manner that does not obscure any underlying textual or graphical information contained on the book, worksheet or test paper.

It is also useful to label different plaques around an exhibit item at a museum, or other display area, with the same data carrier identifier to communicate the same audio information pertaining to a given exhibit item in a manner that does not obscure any underlying textual or graphical information contained on plaques around the exhibit item.

Generally according to existing methods, such as a method disclosed in the '426 application, each label is linked to a particular sound clip and then each label is physically attached to an object. If such a process was utilized to label a multitude of objects that would require the same audio clip, as explained in the previous examples, it would be necessary to individually record a message on each individual data carrier label. If multiple electronic aids were used for the same task, it would be necessary to record an audio message with each electronic aid. This process would be inefficient.

Therefore, a need exists in the art to associate a single audio recording with a plurality of data carriers, each having identical identifiers. A need also exists in the art to store and recall information regarding an identifier, an audio clip and the linkage between the identifier and the audio clip within a plurality of electronic aids in order to efficiently program a plurality of electronic aids for a plurality of individuals to use in the context of the examples explained above.

### SUMMARY OF THE INVENTION

According to the present invention, the foregoing and other objects and advantages are obtained by utilizing a data carrier for use with an electronic aid adapted for reading an identifier printed on the data carrier. The data carrier utilizes a substantially transparent label, a substantially transparent attachment means to permit the label to be attached to an object and the label having at least one identifier. The attachment means can be, for example, a transparent adhesive layer or held by electrostatic adhesion. The label itself can be, for example, plastic or vinyl. The identifier can be, for example, a coded dot pattern. The data carrier can, for example, contain several identical identifiers that are each spaced apart from one another over the surface area of the label.

According to another aspect of the invention, an information recitation method is performed by the steps of reading an identifier printed on a data carrier with an electronic aid capable of reading the identifier, the data carrier having a plurality of identical identifiers spaced over the surface area of the data carrier, storing data associated with the identifier, recording and storing sound information, establishing a link between the data associated with the previously read identifier and the recorded and stored sound information, dividing the data carrier into a plurality of segments whereby each segment has at least one identifier, attaching at least one of the segments to a plurality of tangible objects, reading the identifier located on one said tangible object with the electronic aid, recalling the sound information linked with the previously read identifier with the electronic aid, and playing back the sound information associated with the identifier via an audio output in the electronic aid.

The data stored associated with the identifier, the sound information, and the link between the data associated with the previously read identifier and the recorded and stored sound information can be stored, for example, in memory within the electronic aid. Alternatively, the data stored associated with the identifier, the sound information, and the link between the data associated with the previously read identifier and the recorded and stored sound information may be stored, for example, in the memory within a computer system by a means for data communication to and from at least one electronic aid. Alternatively, data stored associated with the identifier, the sound information, and the link between the data associated with the previously read identifier and the recorded and stored sound information may be stored, for example, in the memory within a first electronic aid and then communicated and stored within the memory of a computer system by a means for data communication to and from the first electronic aid and then further communicated by the computer system by a means for data communication to and from the memory in least one other electronic aid.

The plurality of tangible objects may include, for example, common items in a collection. Each tangible object may include, for example, a plurality of points of attachment for the segments on a single object. The single object may be, for example, an animal's enclosure at a zoo. The single object may be, for example, the display area surrounding an item within museum exhibit. The plurality of tangible objects may include, for example, substantially identical points of attachment for the segments within a plurality of identical pages in a book or set of identical books. The plurality of tangible objects may include, for example, substantially identical points of attachment for the segments within a plurality of identical instructional or testing worksheets. Furthermore, the data carrier may be, for example, substantially transparent.

According to another aspect of the invention, a data carrier is used with an electronic aid adapted for reading an identifier printed on the data carrier, wherein the data carrier comprises a plurality of identifiers, with an improvement comprising the data carrier divided into a plurality of data carriers, whereby each divided data carrier comprises at least one identifier.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a perspective view of data carriers including a zoomed-in perspective view of identifiers according to one embodiment of the invention;

FIG. 2 is a zoomed-in perspective view of a single data carrier and a data carrier divided in half according to one embodiment of the invention;

FIG. 3 is a perspective view of a data carrier according to one embodiment of the invention;

FIG. 4 is a diagram describing a system for carrying out one embodiment of the invention;

FIG. 5 is a diagram describing a system for carrying out one embodiment of the invention;

FIG. 6 is a diagram describing a system for carrying out one embodiment of the invention;

FIG. 7 is a perspective view showing data carrier segments affixed to items in a collection according to one embodiment;

FIG. 8 is a perspective view showing data carrier segments affixed to a zoo animal enclosure according to one embodiment;

FIG. 9 is a perspective view showing data carrier segments affixed to information displays around a museum item according to one embodiment;

FIG. 10 is a perspective view showing data carrier segments affixed to pages in books according to one embodiment; and

FIG. 11 is a perspective view showing data carrier segments affixed to instructional or testing worksheets according to one embodiment.

### DETAILED DESCRIPTION OF THE INVENTION

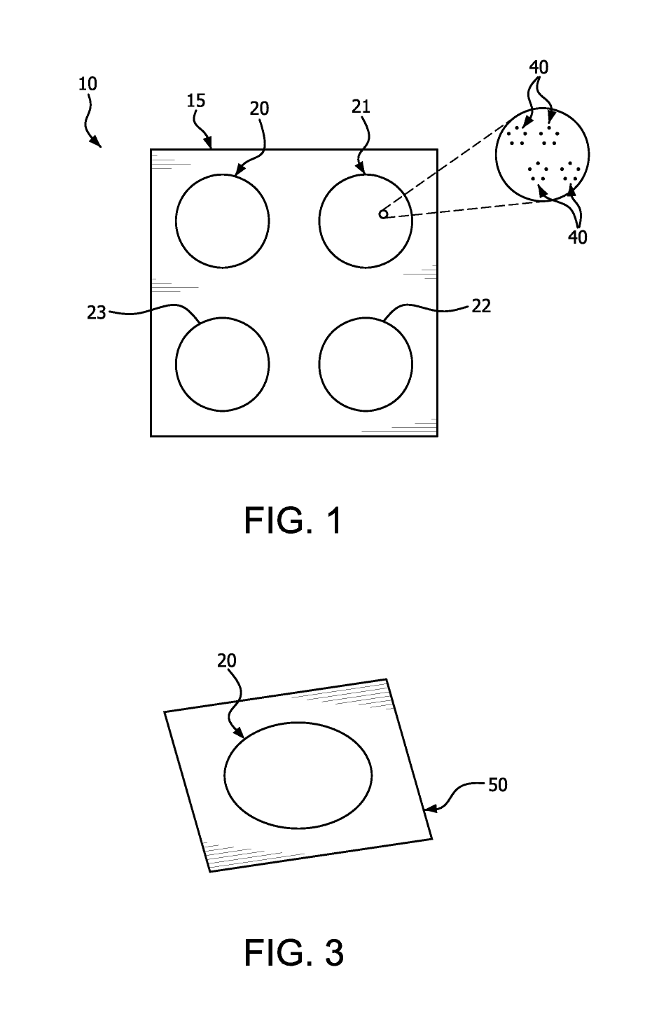

Referring to the drawings wherein like or similar references indicate like or similar elements throughout the several views, there is shown in FIG. 1 a perspective view of data carriers 20-23, including a zoomed in perspective view of identifier 40 according to one embodiment of the invention, generally identified by reference numeral 10.

FIG. 1 depicts sheet 15 upon which data carrier 20 is adhered in a removable manner. Sheet 15 may be formed from plastic, paper, glass, wax paper or any other suitable substance known in the art for adhering labels to a sheet for the purpose of subsequent removal. In one embodiment, data carrier 20 is adhered to sheet 15 with a low-tack adhesive applied to the side of data carrier 20 which contacts sheet 15. In one embodiment, the low-tack adhesive is substantially transparent. In one embodiment, the low-tack adhesive can be subsequently re-used to re-apply data carrier 20 to the surface of another tangible object. In another embodiment, data carrier 20 is adhered to sheet 15 by substantially transparent electrostatic adhesion acting on sheet 15 and the side of data carrier 20 contacting sheet 15. In another embodiment, data carrier 20 can be re-applied to the surface of a compatible tangible object through electrostatic adhesion based on the physical principles described, for example, in U.S. Pat. No. 7,422,648, which is incorporated herein by reference. Data carrier 20 may be adhered to sheet 15 in any other manner recognized by those having ordinary skill in the art.

Data carrier 20 is depicted as a round label, but data carrier 20 may, in other non-depicted embodiments be square, rectangular, triangular or any other shape. Data carrier 20 may be of any size have a surface area greater than or equal to the surface area occupied by a single identifier 40. The zoomed in view in FIG. 1 shows a plurality of identifiers 40 spaced over the surface area of data carrier 20. Data carrier 21, 22 and 23 are also found on sheet 15. Data carrier 21, 22 and 23 are identical to data carrier 20 with the exception that each data carrier 20-23 have a unique identifier 40 pattern.

Identifier 40 is depicted in the embodiment shown in FIG. 1 as a matrix of black and white carbon printed patterns, such as those that may be created by a standard laser printer or by other techniques known in the art. In a preferred embodiment, each identifier 40 consists of a pattern of printed dots too small to be seen by the naked human eye without magnification. In a non-depicted embodiment, the printed dots may take the form of a radial pattern. Other examples of enabling uses of identifier patterns used in a preferred embodiment which are capable of being read with the use of an electronic aid (not depicted) irrespective of the orientation of data carrier 20 are well known in the art. Illustrations of such enabling uses of various identifier patterns used with an electronic aid found in certain embodiments are described in column 3, line 7 through column 5, line 67 of U.S. Pat. No. 7,350,718, column 1, line 9 through column 10, line 13 of U.S. Pat. No. 7,328,845 and U.S. Pat. No. 5,860,679, each of which are incorporated herein by reference.

The pattern of printed dots constituting an identifier may, in other embodiments, be printed with ink that reflects light in the ultraviolet spectrum or the infrared spectrum as opposed to the visible light spectrum. In a preferred embodiment, the pattern of printed dots constituting identifier 20 are designed to be visualized with an electronic aid utilizing a VGA resolution CMOS sensor with a focus adjusted to capture the identifier 20 upon physical contact of the electronic aid with the data carrier 20.

In one embodiment, data carrier 20 can be formed from vinyl, plastic, paper or any other material suitable for receiving printed identifier 40. In another embodiment, data carrier 20 can be, with the exception of the identifiers, blank. In another embodiment, data carrier 20 can be a colored surface with identifiers 40 printed on the colored surface. In a preferred embodiment, data carrier 20 is formed from a substantially transparent plastic (not depicted).

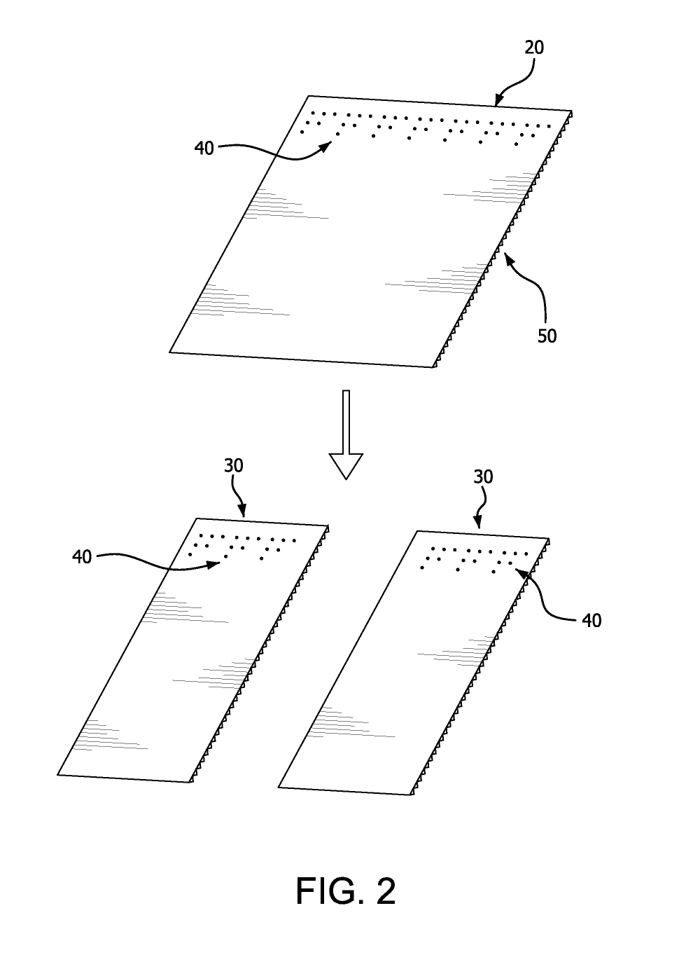

FIG. 2 depicts an embodiment showing data carrier 20 with substantially invisible adhesive layer 50 and a plurality of identifiers 40 which is subsequently divided into segments 30. In this embodiment, each segment 30 contains at least one identifier 40. While not depicted, additional segments 30 are created by dividing data carrier 20 into additional pieces, provided that the smallest piece has enough surface area to contain at least one printed identifier 40.

FIG. 3 depicts an embodiment showing a single data carrier 20 on glass sheet 50 being held to glass sheet 50 by electrostatic adhesion (not depicted).

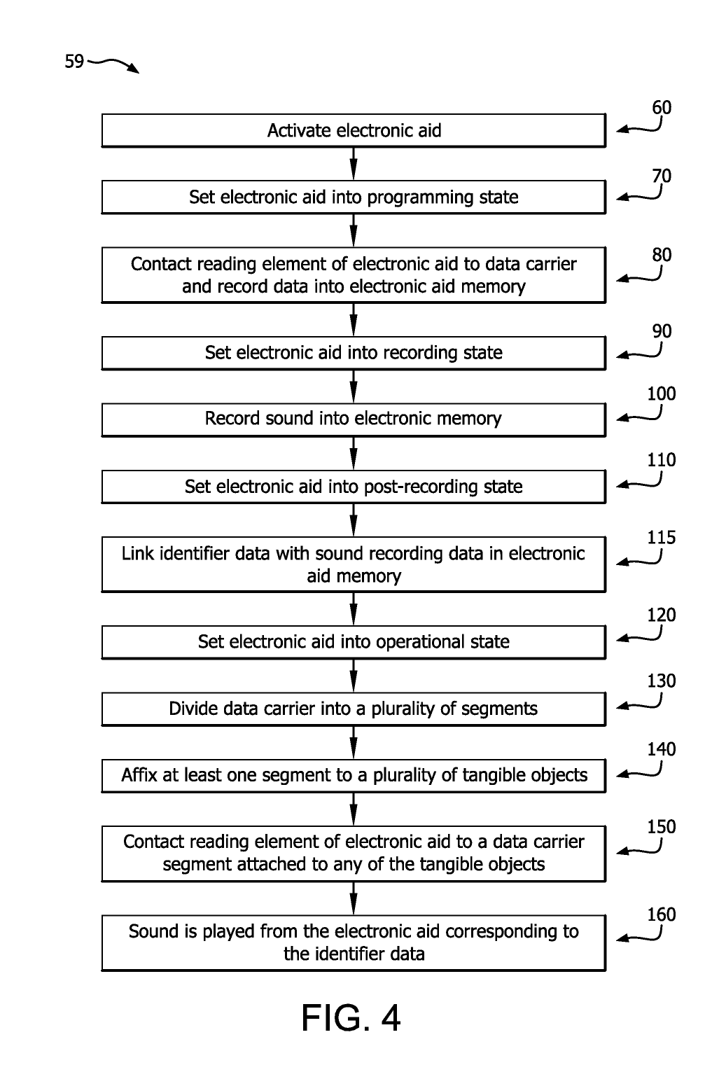

FIG. 4 is a diagram generally identified by reference numeral 59 for carrying out one embodiment. According to this embodiment, step 60 requires an electronic aid to be activated by the user. The electronic aid is set into a programming state in step 70. The reading element of the electronic aid is physically contacted with a data carrier and identifier 40 data is recorded in the electronic aid's memory in step 80. Next, the electronic aid is set into a recording state in step 90. In step 100, sound is recorded by the user into the electronic aid's memory through the use of an electronic microphone on the electronic aid. In step 110, the electronic aid is set into a post-recording state, either automatically after a maximum recording time limit is reached, after the user terminates the recording state or after the electronic aid perceives the lack of audible sound recording for a set period of time. In step 115, the electronic aid links the identifier 40 data with the sound recording data within the memory of the electronic aid. In step 120, the electronic aid is automatically set into an operational state. In step 130, the data carrier 20 is divided by the user into a plurality of segments 30. In step 140, at least one segment is affixed by the user to a plurality of tangible objects. In step 150, the electronic aid's reading element is contacted by the user to the segment 30 attached to any of the tangible objects. In step 160, the sound associated with the identifier 40 is recalled from the electronic aid's memory and replayed through a speaker in or headphone unit connected to electronic aid.

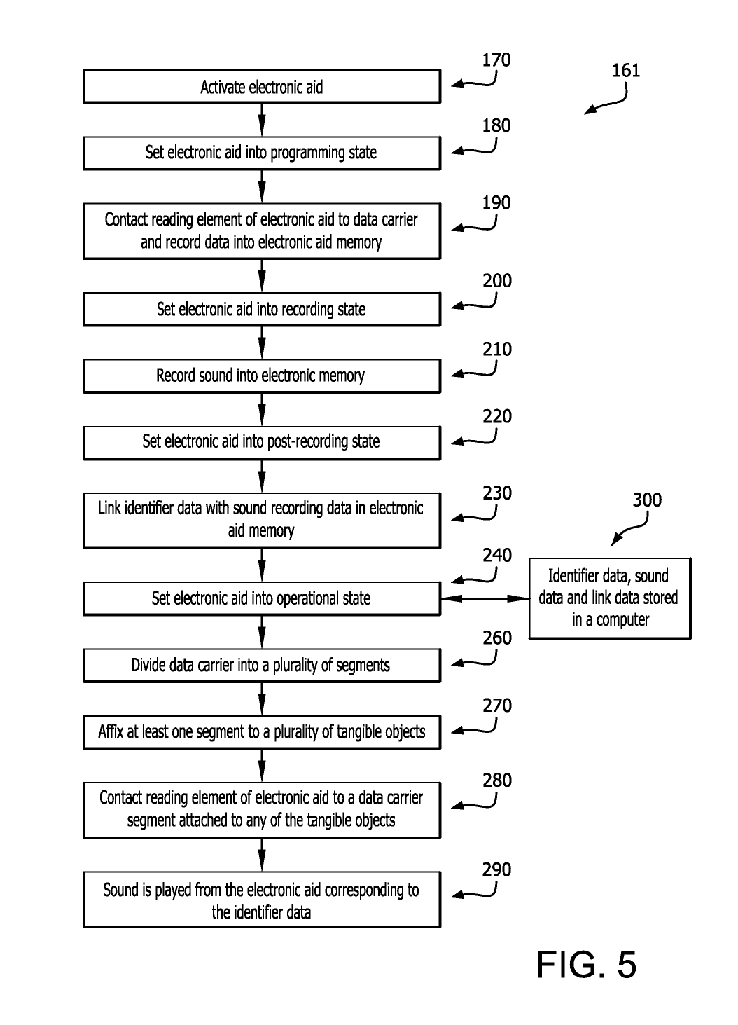

FIG. 5 is a diagram generally identified by reference numeral 161 for carrying out another embodiment. According to this embodiment, step 170 requires an electronic aid to be activated by the user. The electronic aid is set into a programming state in step 180. The reading element of the electronic aid is physically contacted by the user with a data carrier 20 and identifier 40 data is recorded in the electronic aid's memory in step 190. Next, the electronic aid is set into a recording state in step 200. In step 210, sound is recorded by the user into the electronic aid's memory through the use of an electronic microphone on the electronic aid. In step 220, the electronic aid is set into a post-recording state, either automatically after a maximum recording time limit is reached, after the user terminates the recording state or after the electronic aid perceives the lack of audible sound recording for a set period of time. In step 230, the electronic aid links the identifier 40 data with the sound recording data within the memory of the electronic aid. In step 240, the electronic aid is automatically set into an operational state. In step 300, the identifier 40 data, recorded sound data and the data recording the link between the identifier 40 data and the recorded sound data is copied from the electronic aid's memory to the memory of a computer through the use of a wired connection to the computer, such as a USB cable, and the electronic aid, a wireless connection, such as a radio frequency signal, to the computer and the electronic aid, a cellular signal from the electronic aid to the computer, a removable data card readable by the computer and the electronic aid or by any other means known to individuals having ordinary skill in the art. In step 260, the data carrier 20 is divided by the user into a plurality of segments 30. In step 270, at least one segment is affixed by the user to a plurality of tangible objects. In step 280, the electronic aid's reading element is contacted to the segment 30 attached to any of the tangible objects. In step 290, the sound associated with the identifier 40 is recalled from the electronic aid's memory and recited through a speaker in or headphone connected to the electronic aid.

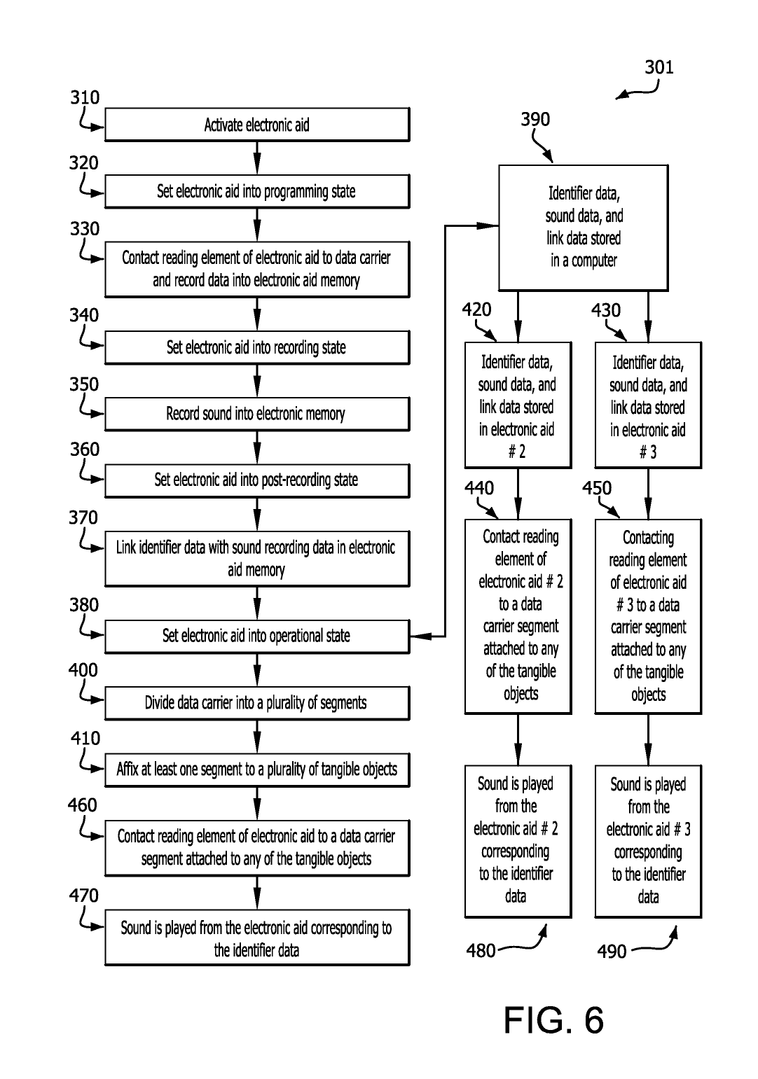

FIG. 6 is a diagram generally identified by reference numeral 301 for carrying out another embodiment. According to this embodiment, step 310 requires an electronic aid to be activated by the user. The electronic aid is set into a programming state in step 320 by the user. The reading element of the electronic aid is physically contacted with a data carrier 20 by the user and identifier 40 data is recorded in the electronic aid's memory in step 330. Next, the electronic aid is set into a recording state in step 340 by the user. In step 350, sound is recorded by the user into the electronic aid's memory through the use of an electronic microphone on the electronic aid. In step 360, the electronic aid is set into a post-recording state, either automatically after a maximum recording time limit is reached, after the user terminates the recording state or after the electronic aid perceives the lack of audible sound recording for a set period of time. In step 370, the electronic aid links the identifier 40 data with the sound recording data within the memory of the electronic aid. In step 380, the electronic aid is automatically set into an operational state. In step 390, the identifier 40 data, recorded sound data and the data recording the link between the identifier 40 data and the recorded sound data is copied from the electronic aid's memory to the memory of a computer through the use of a wired connection, such as a USB cable, to the computer and the electronic aid, a wireless connection, such as a radio frequency signal, to the computer and the electronic aid, a cellular signal from the electronic aid to the computer, a removable data card readable by the computer and the electronic aid or by any other means known to individuals having ordinary skill in the art. In step 420, the identifier 40 data, recorded sound data and the data recording the link between the identifier 40 data and the recorded sound data is copied from the computer's memory to the memory of a second electronic aid through the use of a wired connection, such as a USB cable, to the computer and the second electronic aid, a wireless connection, such as a radio frequency signal, to the computer and the second electronic aid, a cellular signal from the second electronic aid to the computer, a removable data card readable by the computer and the second electronic aid or by any other means known to individuals having ordinary skill in the art. By way of illustration, step 430 is identical to step 420 with the exception that a third electronic aid is employed to receive data in an identical manner from the computer. While not depicted, this process can be repeated to store information on any additional number of independent electronic aides. In another embodiment, the process can also be used with a single additional electronic aid. In step 400, the data carrier 20 is divided into a plurality of segments 30. In step 410, at least one segment is affixed to a plurality of tangible objects. In step 460, the reading element of one of the plurality of previously programmed electronic aids is contacted by the user to the segment 30 attached to any of the tangible objects and the sound associated with the identifier 40 is recalled from the electronic aid's memory and recited through a speaker in or headphone connected to the said electronic aid in step 460. Similarly, in step 440, the second electronic aid can contact the same or another segment 30 attached to any of the tangible objects and the sound associated with the identifier 40 is recalled from the electronic aid's memory and replayed through a speaker in or headphone connected to the electronic aid in step 480. Optionally, a third electronic aid can contact the same or another segment 30 attached to any of the tangible objects and play back the sound associated with the identifier 40 which is recalled from the electronic aid's memory and replayed through a speaker in or headphone connected to the electronic aid in step 490.

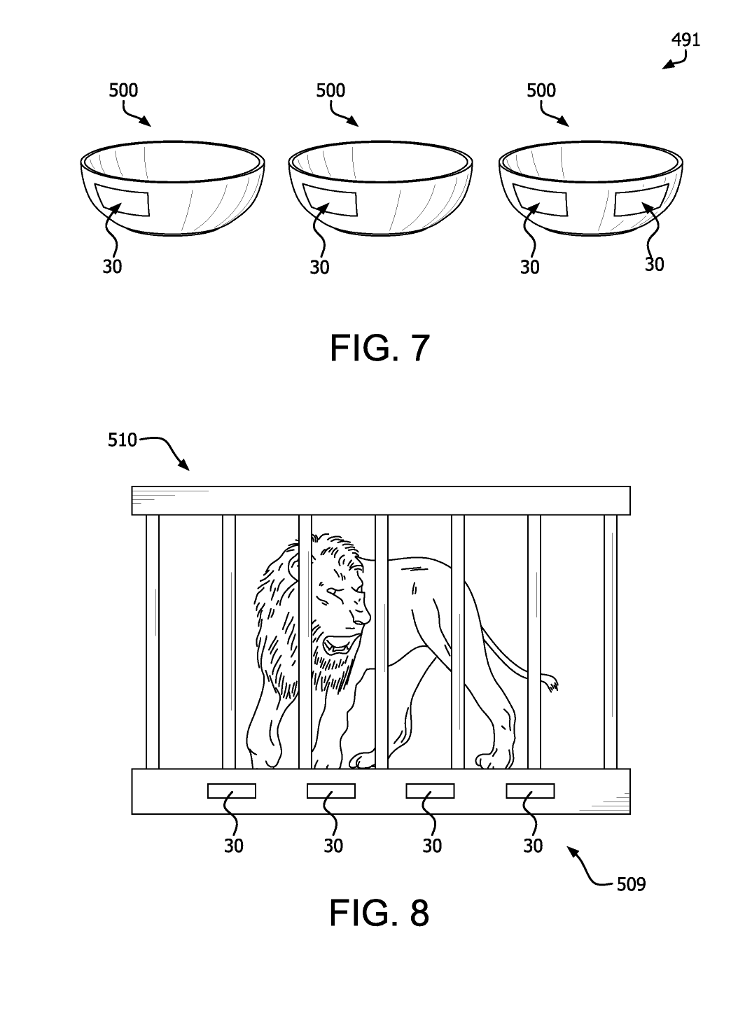

FIG. 7 is a perspective view generally identified by reference numeral 491 for carrying out another embodiment. FIG. 7 depicts three identical objects 500, each commonly labeled with segments 30 taken from a divided data carrier 20, whereby each segment 30 has at least one identifier 40 printed on its surface. As shown in FIG. 7, an identical object 500 may have a single segment 30 physically attached or multiple segments 30 physically attached.

FIG. 8 is a perspective view generally identified by reference numeral 509 for carrying out another embodiment. FIG. 8 depicts zoo animal enclosure 510 having a plurality of segments 30 taken from a divided data carrier 20, whereby each segment 30 has at least one identifier 40 printed on its surface. The single zoo animal enclosure 510 has multiple segments 30 around its perimeter to permit visitors to use electronic aids preprogrammed with recitations as taught herein in order to, for example, listen to applicable audio recordings for a particular zoo animal.

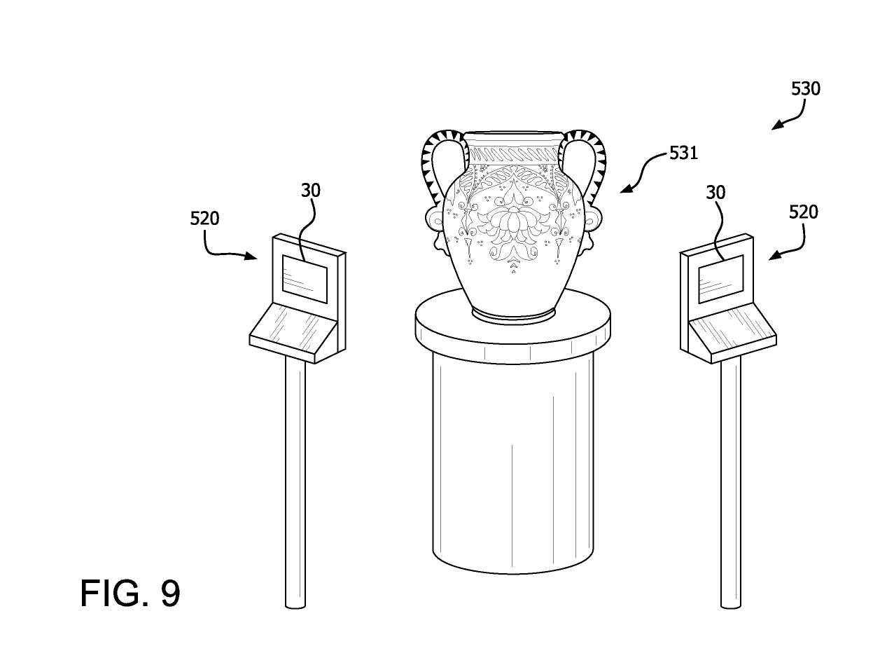

FIG. 9 is a perspective view generally identified by reference numeral 530 for carrying out another embodiment. FIG. 9 depicts an item 531 within a museum exhibit. Also depicted are information stands 520, each having at least one segment 30 taken from a divided data carrier 20, whereby the segment 30 has at least one identifier 40 printed on its surface. The item 531 has multiple segments around its perimeter to permit visitors to use an electronic aid (not depicted) preprogrammed in accordance with the teachings herein to listen to applicable audio recordings for a particular item.

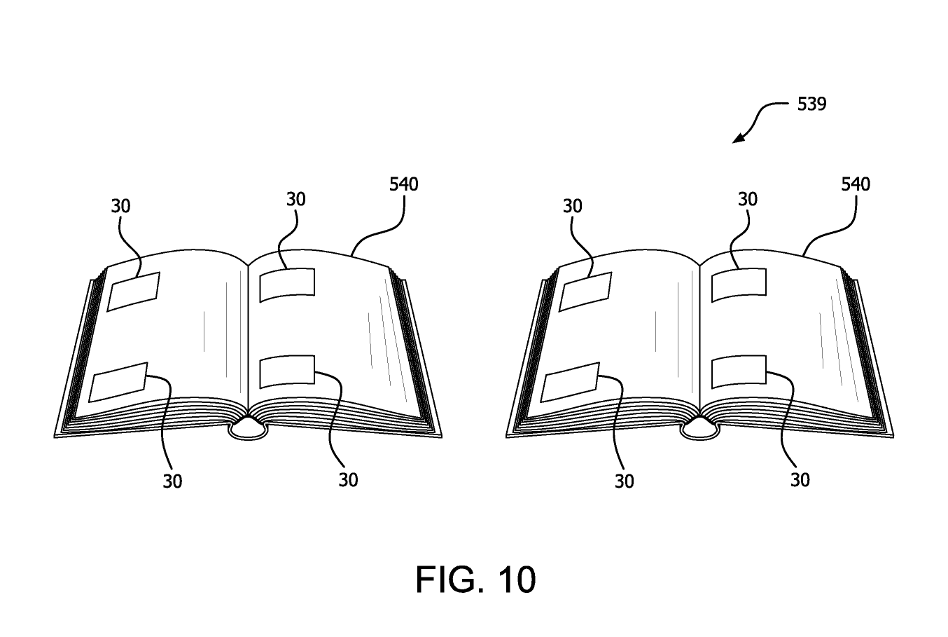

FIG. 10 is a perspective view generally identified by reference numeral 539 for carrying out another embodiment. FIG. 10 depicts identical books, each individually identified by reference numeral 540. Substantially identical places on identical pages of books 540 are labeled with one or more segments 30 taken from a divided data carrier 20, whereby the segment 30 has at least one identifier 40 printed on its surface. This permits readers to use an electronic aid (not depicted) preprogrammed in accordance with the teachings herein to listen to applicable audio recordings for a particular part of a particular page within a particular book. In another embodiment, substantially identical places on identical pages of books 540 are labeled with a plurality of unique segments 30 taken from a different data carrier, such as data carriers 21, 22 and 23 seen in FIG. 1, having at least one identifier 40 printed on its surface. Such recordings are useful for students seeking further verbal instruction, for example, to reinforce a written portion of a text.

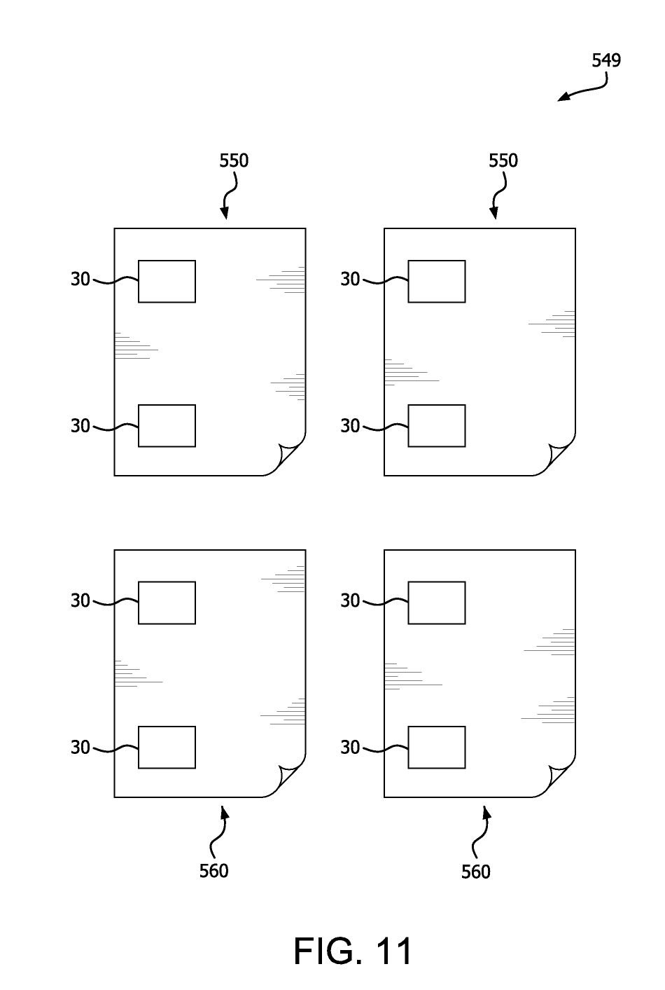

FIG. 11 is a perspective view generally identified by reference numeral 549 for carrying out another embodiment. FIG. 11 depicts identical instructional worksheets, each individually identified by reference numeral 550. Substantially identical places on the instructional worksheets 550 are labeled with one or more segments 30 taken from a divided data carrier 20, whereby the segment 30 has at least one identifier 40 printed on its surface. This permits readers to use an electronic aid (not depicted) preprogrammed with the teachings herein to listen to applicable audio recordings for a particular part of a particular page of worksheet 550. In another embodiment, substantially identical places on identical pages of instructional worksheets 550 are labeled with a plurality of unique segments 30 taken from a different data carrier, such as data carriers 21, 22 and 23 seen in FIG. 1, having at least one identifier 40 printed on its surface. Such recordings are useful for students seeking further verbal instruction, for example, to reinforce a written portion of a text.

FIG. 11 also depicts identical testing worksheets, each individually identified by reference numeral 560. Substantially identical places on the testing worksheets 560 are labeled with one or more segments 30 taken from a divided data carrier 20, whereby the segment 30 has at least one identifier 40 printed on its surface. This permits readers to use an electronic aid (not depicted) to listen to applicable audio recordings for a particular part of a particular page of testing worksheet 560. In another embodiment, substantially identical places on identical pages of testing worksheets 560 are labeled with a plurality of unique segments 30 taken from a different data carrier, such as data carriers 21, 22 and 23 seen in FIG. 1, having at least one identifier 40 printed on its surface. Such recordings are useful for students seeking further verbal instruction, for example, to reinforce a written portion of a text.

Although the invention has been described in detail for the purpose of illustration, it is to be understood that such detail is solely for that purpose and that variations can be made therein by those skilled in the art without departing from the spirit and scope of the invention as claimed herein.

1. A data carrier for use with an electronic aid adapted for reading an identifier printed on the data carrier comprising:
a transparent label;
a transparent attachment means to permit the label to be attached to an object;
the label having at least two identical identifiers spaced apart from one another over the surface area of the label with the use of blank space between each identical identifier to separate each identical identifier; and
the label being divided into at least two segments, whereby each segment has at least one identical identifier.

2. A data carrier according to claim 1, wherein the attachment means is a substantially transparent adhesive layer.

3. A data carrier according to claim 1, wherein the attachment means is electrostatic adhesion.

4. A data carrier according to claim 1, wherein the label is plastic.

5. A data carrier according to claim 1, wherein the label is vinyl.

6. A data carrier according to claim 1, wherein the at least two identical identifiers are a coded dot pattern.

7. (canceled)

8. An information recitation method comprising the steps of:
reading an identifier printed on a data carrier with an electronic aid adapted to read the identifier, the data carrier having a plurality of identical identifiers spaced over a surface area of the data carrier;
storing data associated with the identifier;
recording and storing sound information;
establishing a link between the data associated with the previously read identifier and the recorded and stored sound information;
dividing the data carrier into a plurality of segments whereby each segment has at least one identical identifier and blank space is used between each identical identifier to separate each identical identifier;
attaching at least one of the segments to a plurality of tangible objects;
reading the identifier located on one said tangible object with the electronic aid;
recalling the sound information linked with the previously read identifier with the electronic aid; and
playing back the sound information associated with the identifier via an audio output in the electronic aid.

9. The information recitation method according to claim 8, wherein the data carrier is substantially transparent.

10. The information recitation method according to claim 8 or 9, wherein the data stored associated with the identifier, the sound information, and the link between the data associated with the previously read identifier and the recorded and stored sound information is stored in memory within the electronic aid.

11. The information recitation method according to claim 10, wherein the plurality of tangible objects includes identical items in a collection.

12. The information recitation method according to claim 10, wherein the plurality of tangible objects includes substantially identical points of attachment for the segments on identical pages in a plurality of identical books.

13. The information recitation method according to claim 10, wherein the plurality of tangible objects includes substantially identical points of attachment for the segments within a plurality of identical instructional or testing worksheets.

14. The information recitation method according to claim 10, wherein the plurality of tangible objects includes a plurality of points of attachment for the segments on a single object.

15. The information recitation method according to claim 14, wherein the single object is an animal's enclosure at a zoo.

16. The information recitation method according to claim 14, wherein the single object is the display area surrounding an item within museum exhibit.

17. The information recitation method according to claim 8 or 9, wherein the data stored associated with the identifier, the sound information, and the link between the data associated with the previously read identifier and the recorded and stored sound information is stored in the memory within a computer system by a means for data communication to and from at least one electronic aid.

18. The information recitation method according to claim 17, wherein the plurality of tangible objects includes substantially identical points of attachment for the segments on identical pages in a plurality of identical books.

19. The information recitation method according to claim 17, wherein the plurality of tangible objects includes substantially identical points of attachment for the segments within a plurality of identical instructional or testing worksheets.

20. The information recitation method according to claim 17, wherein the plurality of tangible objects includes identical items in a collection.

21. The information recitation method according to claim 17, wherein the plurality of tangible objects includes a plurality of points of attachment for the segments on a single object.

22. The information recitation method according to claim 21, wherein the single object is an animal's enclosure at a zoo.

23. The information recitation method according to claim 21, wherein the single object is the display area surrounding an item within museum exhibit.

24. The information recitation method according to claim 8 or 9, wherein the data stored associated with the identifier, the sound information, and the link between the data associated with the previously read identifier and the recorded and stored sound information is first stored in the memory within a first electronic aid and then communicated and stored within the memory of a computer system by a means for data communication to and from the first electronic aid and then further communicated by the computer system by a means for data communication to and from the memory in least one additional electronic aid.

25. The information recitation method according to claim 24, wherein the plurality of tangible objects includes substantially identical points of attachment for the segments on identical pages in a plurality of identical books.

26. The information recitation method according to claim 24, wherein the plurality of tangible objects includes substantially identical points of attachment for the segments within a plurality of identical instructional or testing worksheets.

27. The information recitation method according to claim 24, wherein the plurality of tangible objects includes identical items in a collection.

28. The information recitation method according to claim 24, wherein the plurality of tangible objects includes a plurality of points of attachment for the segments on a single object.

29. The information recitation method according to claim 28, wherein the single object is an animal's enclosure at a zoo.

30. The information recitation method according to claim 28, wherein the single object is the display area surrounding an item within museum exhibit.

31. A data carrier for use with an electronic aid adapted for reading an identifier printed on the data carrier, wherein the data carrier comprises a plurality of identifiers,
an improvement comprising:
the data carrier divided into a plurality of data carriers, whereby each divided data carrier comprises at least one identical identifier with the use of blank space between each identical identifier to separate each identical identifier.

32. The data carrier of claim 31, wherein the data carrier is substantially transparent.
